(19) United States
(12) Patent Application Publication
(10) Pub. No.: US 2011/0147308 A1
(43) Pub. Date: Jun. 23, 2011

(54) Charged Porous Polymeric Membranes and Their Preparation

(75) Inventors: Geoffrey JOHNSTON-HALL, Springwood (AU); Heinz-Joachim Muller, Woy Woy (AU); Dongliang Wang, Parramatta (AU)

(73) Assignee: Siemens Water Technologies Corp., Warrendale, PA (US)

(21) Appl. No.: 12/973,508

(22) Filed: Dec. 20, 2010

(30) Foreign Application Priority Data
Dec. 21, 2009 (AU) 2009906191

(51) Int. Cl. B01D 71/06; B01D 69/08; B01D 61/00; B01D 71/16; B01D 71/34; B01D 71/62; B01D 67/00

(52) U.S. Cl. 210/650; 210/500.27; 210/500.42; 210/500.33; 210/500.3; 210/500.43; 210/500.23; 210/500.28; 521/54

(57) ABSTRACT

A charged porous polymeric membrane comprises a porous polymeric membrane substrate comprising a polymeric membrane material and a first polymer having a first functional group, the first polymer is compatible with the membrane material, and a charged polymer has a second functional group, the charged polymer can react with the first polymer to bond the charged polymer to the first polymer, forming a charged coating on the membrane outer and inner surfaces. The membrane may be a microporous or an ultrafiltration membrane. The membrane may be a hollow fiber, flat sheet, or tubular membrane. Methods of manufacturing the membranes and method of using of the membranes to remove viral particles from contaminated water are further described.

### FIELD OF THE INVENTION

Embodiments of the present invention relate to charged porous polymeric membranes for use in ultrafiltration and microfiltration and to methods of preparing said membranes.

### BACKGROUND

Membranes are well known in the art for removal of a variety of dissolved or suspended species, either contaminants or products, from solution or from the carrier fluid. Microfiltration, ultrafiltration and nanofiltration membranes remove such species from solutions by a number of mechanisms. Suspended species can be removed by mechanical exclusion wherein particles larger than the pore size of the membrane are removed from the fluid, producing a purified filtrate product. Filtration efficiency in this mechanism is largely controlled by the size of the contaminant particle relative to the pore size of the membrane.

Membranes may also remove species suspended or dissolved species by adsorption onto or repulsion from the membrane surfaces. Surface includes the outer or facial surface of the membrane and may include the interstitial or pore surfaces in some cases. Removal by this mechanism is controlled by the interactions of the surface characteristics of the suspended species and those of the membrane. These interactions may include, but are not limited to hydrogen bonding, hydrophobic attraction between opposite charges or repulsion of similar charges on the membrane and the solute.

Many of the polymers used for making microfiltration and ultrafiltration membranes are well known engineering plastics, such as polyolefins, polyvinylidene difluoride (PVDF), polyethersulfone (PES), polysulfone (PSf), polyacrylonitrile (PAN) cellulose acetate (CA), and the like. These materials provide desirable structural characteristics and mechanical strength to the membrane. Microporous and ultrafiltration polymeric membranes are particularly suitable for use in hollow fibres and are usually produced by phase inversion. In this process, at least one polymer is dissolved in an appropriate solvent and optionally other additives may be included in order to control final membrane structure. The polymer solution can be formed into a film or hollow fibre by a suitable coating or extrusion process step, and the formed solution immersed in precipitation bath of a non-solvent which is miscible with the solvent system. Water or water with added solvent are common non-solvents. This process is termed the casting process, or the spinning process in the case of producing hollow fiber membranes. The homogeneous polymer solution separates into a solid polymer phase and liquid phase. By controlling the initial polymer solution and the process variables (e.g., non-solvent composition, precipitation temperature, and process operational variables) the precipitated polymer forms a porous structure containing an interconnected network of pores. Production parameters that affect the membrane structure and properties include the polymer concentration, the precipitation media and temperature and the amount of solvent and non-solvent in the polymer solution. These factors can be varied to produce microporous membranes with a large range of pore sizes (from less than about 0.1 to about 20 microns) or ultrafiltration membranes having nominal pore sizes of from about 10 nanometers to about 100 nanometers, and possess a variety of chemical, thermal and mechanical properties. Methods of making membranes using phase separation membranes are discussed in “Microfiltration and Ultrafiltration Principles and Practice” Leos J. Zeman and Andrew L. Zydney; Marcel Dekker (1996).

However, the uncharged and hydrophobic surface of membranes made from engineering polymers used and produced by such processes often results in the frequent heavy fouling of the membrane surface in a variety of applications.

In microfiltration, ultrafiltration and nanofiltration applications, it is known in the art that the performance of the membrane can be improved by attaching ionic functional groups to the membrane which would serve to provide a fixed charge on the surface. Such membranes can be utilised in environmental, pharmaceutical, food processing and water filtration applications for the removal of a variety of species from the feed solutions being processed and to provide fouling resistance to similarly charged contaminants. Various methods have been disclosed for the manufacture of such charged membranes, for use in a variety of applications.

U.S. Pat. No. 6,565,748 discloses a charge-modified polymer membrane produced by modifying an initially hydrophobic sulfone polymer membrane by contact with a hydrophilic polymer in solution following which the membrane is simply contacted simultaneously with a first and second charge-modifying agent in aqueous solution for a brief period, following which the membrane is dried under thermal conditions designed to induce crosslinking. The first cationic charge-modifying agent may be a polyamine, such as hydroxyethylated polyethyleneimine (HEPEI) or an aziridine-ethylene oxide copolymer. The second cationic charge-modifying agent may be either a high or low molecular weight epichlorohydrin-modified highly branched polyamine.

A formed initially hydrophobic membrane made hydrophilic by contacting with a solution of polymeric wetting agents may also be contacted briefly with either the first or second charge-modifying agent alone in aqueous solution, followed by drying under thermal conditions to induce crosslinking, to produce a cationic charge-modified membrane.

Charge modification results from casting a film of mixed polymer solution including a sulfone polymer, a copolymer of vinylpyrrolidone and a cationic imidazolinium compound. The film is quenched in a bath to result in a cationic charged membrane. The membrane can then be further cationically charge-modified with an additional charge-modifying agent.

Further, U.S. Pat. No. 4,849,106 discloses a method for preparing a fouling-resistant polymer membrane wherein a PVDF polymer is blended with a negatively charged sulfonated vinyl amino compound and extruded to give a negatively charged membrane. The negatively charged membrane is then treated with a solution of polyethylene imine having fixed, positively charged nitrogen groups such that an excess of positively charged nitrogen groups is present on the treated membrane.

Alternative methods of producing charged polymeric membranes are also known in the art, wherein a charged polymer is coated onto a preformed porous membrane substrate. For example, U.S. Pat. No. 5,282,971 discloses a PVDF membrane having a polymer containing positively charged quaternary ammonium groups polymerized and covalently bonded to the membrane, preferably by gamma irradiation, during membrane post-treatment. Further, U.S. Pat. No. 5,114,585 discloses a pre-formed membrane substrate that is rendered charged by post-treating to physically adsorb polyvinylpyridine or polyalkyleneimine to the membrane surface, and further treating and reacting with a difunctional alkylating agent such as a dihaloalkane.

In addition to the good mechanical properties and high chemical resistance required by membranes used in water filtration, it is also desirable that such membranes have good permeability and high retention of contaminants. Further, to achieve the highest possible fouling resistance it is required that the surface of the modified membrane possess the maximum possible surface charge density. Thus, it is required that the entire surface of the membrane be modified with the desired surface characteristic and that the resultant modified membrane has the same or improved porosity characteristics as the unmodified membrane.

European Patent Application No. EP 0772 488 discloses a hydrophobic porous membrane substrate formed of a first polymer such as PVDF coated over its entire surface by a second water-soluble polymer composition such as polyvinyl alcohol or polyacrylamide. The second polymer is rendered insoluble by surface grafting using mild heat or exposure to UV light. The membrane of EP 0772 488 retains the bulk properties of the porous membrane substrate while retaining modified properties over the entire membrane surface. The modified surface may be further charged anionically or cationically.

U.S. Pat. No. 5,137,633 discloses a porous hydrophobic substrate, such as that made from PVDF, having its surface modified with a coating to render the surface hydrophilic and modified with positive charges. The surfaces of the hydrophobic substrate are modified by passing the substrate through a solution including: a hydrophilizing component of a monomer derived from an acrylate capable of being polymerised by free radical polymerisation and which is cross-linked using an optional cross-linking agent and a non-ionic or cationic polymerisation initiator for the monomer; and a charge-modifying agent including a polyamine epichlorohydrin cationic resin.

Anionic polymerisation initiators cannot be used as they promote undesirable precipitation of the cationic resin. The substrate is then exposed to an energy source for initiating free radical polymerisation such as ultraviolet light in order to polymerise and cross-link the precursor to the hydrophilic polymer. In addition, some cross-linking of the polyamine resin occurs in this step. The membrane is then further exposed to heat in order to completely cross-link the polyamine-polyamide epichlorohydrin cationic resin. The resultant product includes a hydrophobic porous substrate having its surfaces coated with a polymer network formed of the cross-linked hydrophilic resin and the cross-linked polyamine epichlorohydrin resin.

U.S. Pat. No. 5,151,189 describes a positively charged microporous membrane formed by casting a sulfone polymer membrane solution containing either PVP or polyethylene oxide (PEO) or both. The membrane is treated with alkaline solution which opens the amide ring of PVP and renders it reactable with epoxy groups. The alkaline treated membrane is contacted with a primary charge modifying agent comprising a polyethyleneimine-epichlorohydrin polymer which reacts with the opened ring of PVP or with the end group hydroxyl of PEO. A second charge modifying agent selected from the group of phosphinated polybenzyl chloride or ammonium or sulfonium analogs may be reacted with the primary charge modifying polymer.

U.S. Pat. No. 5,277,812 relates to a positively charged microporous membrane formed by casting in a film a polymer matrix blend solution comprising polyethersulfone, polyvinylpyrrolidone, polyfunctional glycidyl ether, and polyethyleneimine, precipitating the resulting film as a membrane in a quench bath, and washing and drying the precipitated membrane.

There remains a need for a charged membrane and a process for its production that is relatively simple to manufacture and wherein said process does not deleteriously affect the filtration properties of the membrane. Of particular importance is the ability to provide a controlled amount of crosslinking in order to optimize membrane properties. Furthermore, there is a need for such a membrane which has an improved charge content over previous membranes and that retains its charged properties over multiple filtration and cleaning operations.

Further membrane characteristics including fouling resistance to oppositely charged contaminants, the specific adsorption or repelling of a particular foulant and improved virus retention over the uncharged membrane substrate are also desirable.

It is an object of the present invention to overcome or ameliorate at least one of the disadvantages of the prior art, or to provide a useful alternative.

### SUMMARY

In an embodiment, the present invention comprises a charged porous polymeric membrane comprising a porous polymeric membrane substrate comprising a polymeric membrane material and a first polymer having a first functional group, said first polymer compatible with the membrane material, and a charged polymer having a second functional group, said charged polymer reacted with said first polymer to bond said charged polymer to said first polymer, forming a charged coating on the membrane outer and inner surfaces. The membrane may be a microporous or an ultrafiltration membrane. The membrane may be a hollow fiber, flat sheet or tubular membrane.

In an embodiment, the polymeric membrane material comprises a polymer selected from the group consisting of polyvinylidene difluoride (PVDF), polyethersulfone (PES), polysulfone (PSf), polyacrylonitrile (PAN) or cellulose acetate (CA).

In an embodiment, the polymeric membrane material comprises polyvinylidene difluoride (PVDF). In an embodiment, the polymeric membrane material comprises a semicrystalline polymer.

In an embodiment, the first polymer is compatible with the membrane material polymer.

In other embodiments, the first polymer may comprise more than one polymer species, and/or may have more than one functional group.

In an embodiment, the first polymer comprises polyvinylpyrrolidone or copolymers of polyvinylpyrrolidone. In a preferred embodiment, the first polymer is poly(vinylpyrrolidone)/vinylacetate copolymer.

In other embodiments the charged polymer may be negatively charged, positively charged, or be a zwitterion. In embodiments where the charged polymer is negatively charged, the preferred polymer is a PVP copolymer selected from the group consisting of PVP copolymers having sulfonic acid or carboxylic acid groups. In embodiments where the charged polymer is positively charged, the preferred polymer is a PVP copolymer selected from the group consisting of poly(vinylpyrrolidone/alkylaminomethacrylate) copolymer, poly(vinylpyrrolidone/alkylaminomethacrylamide) copolymer, and poly(vinylpyrrolidone/methacrylamidopropyl trimethylammonium chloride) copolymer. In preferred embodiments, the positively charged PVP copolymer is poly(vinylpyrrolidone/methacrylamidopropyl trimethylammonium chloride) or poly(vinylpyrrolidone/dimethylaminoethylmethacrylate) copolymer.

In embodiments wherein the charged polymer is a zwitterion, a preferred PVP copolymer is selected from a group consisting of PVP copolymers having both positively and negatively charged amine, amide, modified amine or modified amide groups or any combination thereof.

Embodiments of the present invention provide for a method of manufacturing a charged porous membrane which method comprises the steps of: providing a porous membrane substrate comprising a membrane material polymer and an embedded first polymer, reacting said first polymer with a charged polymer to bond said charged polymer to said first polymer, thereby forming a charged polymeric coating on the surface of the membrane substrate.

In other embodiments of the present invention the first polymer is reacted with the charged polymer by bringing the membrane substrate in contact with a liquid solution of the charged polymer and causing the solution containing the charged polymer to be brought to a condition where reaction between the charged polymer and the first polymer will occur. In preferred embodiments the liquid is water, alcohols or combinations of water and alcohol.

In some embodiments the liquid solution contains a free radical initiator. In embodiments using free radical initiators, preferred initiators are selected from the group consisting of persulfate, peroxide and azo compounds. In more preferred embodiments, the free radical initiator is selected from the group of azobiscyanovaleric acid, benzoyl peroxide, ammonium persulfate, sodium persulfate and potassium persulfate. A most preferred free radical initiator is ammonium persulfate.

In some embodiments reacting the first polymer with the charged polymer comprises the steps of: bringing the membrane substrate in contact with a liquid solution of the charged polymer, optionally removing excess solution to leave the membrane substrate substantially saturated with solution, and irradiating the liquid solution with gamma radiation or electron beam radiation to cause reaction to occur between the charged polymer and the first polymer.

In embodiments of the present invention, the reaction occurs when a free radical initiator is caused to generate a free radical by supplying energy to the liquid solution containing a free radical initiator, wherein the supplied energy is selected from the group of thermal, ultraviolet irradiation, electron beam irradiation, gamma irradiation and combinations of said supplied energies.

Embodiments of the present invention comprise a method for removing viral contaminants from a fluid.

### BRIEF DESCRIPTION OF THE DRAWINGS

FIG. 1 shows images taken via scanning electron microscope (SEM) of a membrane prepared according to the method of the present invention.

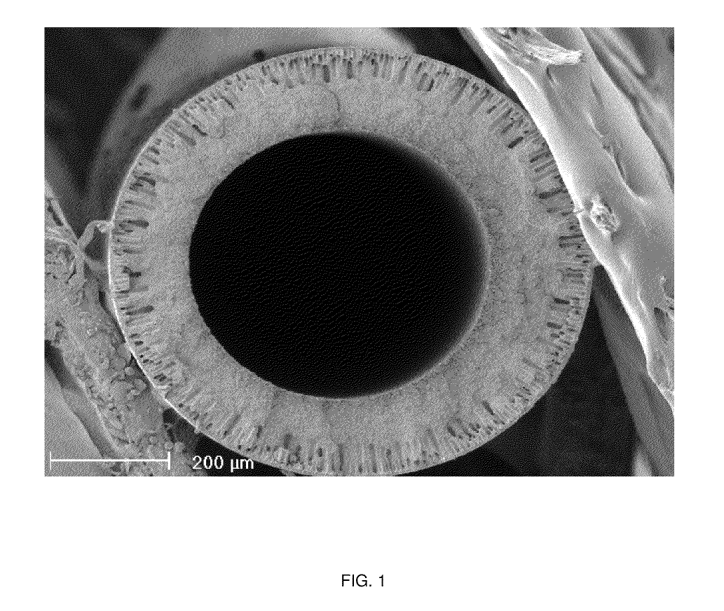

FIG. 2 is a flow chart illustrating the general steps used in the method of membrane production of embodiments of the present invention.

### DETAILED DESCRIPTION

The inventors describe herein several embodiments of a novel charged porous polymeric membrane and a process for making said membranes. The membrane is comprised of: a porous polymeric membrane substrate comprising an compatible mixture of a polymeric membrane formation material and a first polymer having a first functional group and a second polymer reacted with the first polymer having a first functional group, the second polymer being a charged polymer with a second functional group, wherein said first polymer having said first functional group secures and holds said charged polymer having said second functional group such that a coating of a mechanically stable water insoluble gel is formed on the surfaces of the porous polymeric substrate.

The term “react” is used herein to define any interaction between chemical species, including physical mechanical bonding and chemical bonding such as hydrogen bonding, ionic bonding and covalent bonding. This definition is not exclusive and may incorporate other interactions between chemical species not listed here.

Membrane material refers to the main primary polymer used to produce the membrane. Without limiting the scope of the description of the embodiments herein, examples of such polymers are polyvinylidene difluoride (PVDF), polyethersulfone (PES), polysulfone (PSf), polyacrylonitrile (PAN) and cellulose acetate (CA).

Functional groups are specific groups of atoms within a polymer, either as part of one or more of the repeating units or randomly located when added by a secondary reaction that provide specific chemical reactivity or physical-chemical behaviour.

The surface of a membrane comprises the outer surface and the surfaces of the interstitial pore surfaces. For a hollow fiber membrane, the outer surfaces are the outer and inner walls of the hollow fiber. For a flat sheet membrane, the outer surfaces are the opposing sides of the sheet.

The coating is described as mechanically stable, meaning that it is not easily removed by contact with other membrane surfaces as can occur in arrays of hollow fibers or by physical cleaning during normal use.

The term “react” is used herein to define any interaction between chemical species, including physical mechanical bonding and chemical bonding such as hydrogen bonding, ionic bonding and covalent bonding. This definition is not exclusive and may incorporate other interactions between chemical species not listed here.

Preferably, the charged polymer coating having the second functional group is chemically bonded to the polymer having the first functional group in the membrane substrate to form the water insoluble gel. More preferably, the charged polymer coating having the second functional group is grafted to said polymer having said first functional group in said membrane substrate to form said water insoluble gel.

The polymer with the first functional group is preferably embedded in the membrane substrate. This is designed to improve the stability of this reactive functional group to provide an ‘anchor’ when reacted with the functional group of the charged polymer. The embedded polymer containing the first functional group is preferably miscible with the polymeric membrane formation material. Thus, the compatibility of the embedded polymer ‘anchor’ assists with the improved stability of the charged polymer membrane over its operational life span.

The invention will now be described particularly in relation to charged hollow fibre microfiltration and ultrafiltration membranes. Although the invention will be described with reference to specific examples, it will be appreciated by those skilled in the art that the invention may be embodied in many other forms. These additional forms comprise hollow fibre membranes or tubular membranes used for ultrafiltration and nanofiltration membranes, reverse osmosis membranes and flat sheet membranes.

In order to manufacture a preferred embodiment of a charged membrane according to the method of the present invention, at least one polymer containing a first functional group can be embedded in the membrane forming material during the process of membrane formation. This embedded polymer is designed to act as an ‘anchor’ in the membrane substrate for the attachment of additional functional units such as for example grafting of the charged polymer containing the second functional group. The preferred membrane forming materials comprise polyvinylidene difluoride (PVDF), polyethersulfone (PES), polysulfone (PSf), polyacrylonitrile (PAN) and cellulose acetate (CA), for excellent mechanical strength and ease of pore formation during casting. Practitioners skilled in the art of making porous membranes will realize that other polymers may be appropriate for other membrane applications and will be able to readily adapt the teachings herein to those polymers. The polymeric membrane formation material, such as PVDF or PES, is dissolved in an appropriate solvent mixture such as N-methylpyrrolidone (NMP), dimethyl acetamide (DMA), dimethyl formamide (DMF) and dimethyl sulfoxide (DMSO) along with a PVP or PVP/VA copolymer to prepare a homogenous polymer solution, sometimes called a dope or a spinning dope.

Most microporous and ultrafiltration hollow fiber membranes are produced by phase separation from polymer solutions. The membrane developer will develop an empirical polymer-solvent-additive system which will produce the desired pore size and porosity when phase separation occurs. The additive may be a non-solvent, for example water, alcohols or other poor or non-solvents. The additive may be a compatible polymer, or a salt; lithium salts are one example. The solution is formed into a desired shape by well known processes. For flat sheet membranes, various coating or extrusion methods are used to produce a thin sheet of the solution on a support. Hollow fiber membranes are formed by an annular die. After the solution is formed to the desired shape, phase separation is induced in a subsequent step.

Phase separation is commonly accomplished by one of three processes: an immersion process, (LIPS—liquid induced phase separation or DIPS—diffusion induced phase separation; either term may be used) where the formed polymer solution is immersed into a miscible non-solvent (water is commonly used) to remove the solvent and cause phase separation and solidification into a porous solid. In vapor induced phase separation (VIPS), heated air, usually of a controlled humidity, evaporates the solvent system in a convective oven accompanied by water vapor absorption. The solvent system consists of a good solvent with a high vapor pressure and a poor solvent with a lower vapor pressure. Evaporation changes the solvent quality into a poor or a non-solvent by removing the high vapor pressure component, causing polymer precipitation. A change in temperature of the solution which brings the solution below its upper critical solution temperature will induce precipitation. This is the TIPS—temperature induced phase separation process. A related process, HIPS-heat induced phase separation, raises the solution temperature above the lower critical solution temperature, again causing phase separation. In this process, the heated solution is immersed in a non-solvent after the heat induce phase separation occurs. Hollow fiber membranes are primarily made by the immersion method, or in some cases, by the thermal method.

The DIPS process has an advantage that asymmetric membranes can easily be formed. In addition, the spinning of hollow fibres can be performed at room temperature, whereas the alternative process—thermally induced phase separation (TIPS) requires much higher temperatures. Since DIPS uses the diffusion of non-solvent and solvent it is relatively easy to control the rate at which membrane formation takes place by changing the concentration of the non-solvent bath and the polymer solution. The disadvantage however, is that macrovoids, finger-like intrusions in the membrane, may be formed. They decrease the mechanical strength of the membrane but can be avoided by choosing the right composition of solution. The base membranes of the present invention are preferably manufactured using a DIPS process.

The polymer used for the membrane material polymer primarily determines the physical properties of the membrane. Polymers used as the membrane material fall into the classes of glassy polymers and semi-crystalline polymers. Glassy polymers need to have a glass transition temperature (Tg) well above their operating use temperature in order to maintain mechanical strength. PES, probably the most common glassy polymer used for membranes, has a glass transition temperature of around 190° C.-220° C., depending on the manufacturer and grade. When used at temperatures near the freezing point of water, PES membranes can become brittle and fragile. Semi-crystalline polymers with low Tg's and higher melting points (Tm), such as PVDF, (Tm˜177° C., Tg˜ −35° C.) maintain their mechanical strength due to the high melting crystallites in the polymer, yet remain flexible at low temperatures because of their low Tg. In applications such as membrane bioreactors (MBR) used in cold climates, this is a decided advantage.

Polyvinylpyrrolidone or poly(vinylpyrrolidone)/vinylacetate copolymers are the preferred polymer additives for the casting solution. These polymers are compatible with PVDF, PES, Psf and other polymers used for membrane production. Compatibility is usually defined as meaning that a compatible blend of polymers will have a single glass transition temperature (Tg) intermediate between the Tg's of the blend components. In a practical sense, a solution of a blend of compatible polymers will be clear, and when precipitated, the solid phase will have substantially the same ratio of polymer to additive as the casting solution, with the additive polymer substantially uniformly dispersed in the membrane. In this way, the solidified phase will have the additive polymer embedded in the membrane structure.

The membrane is washed with a non-solvent such as water, ethanol, methanol or isopropanol and the polymeric membrane formation material is embedded with the PVP or PVP/VA copolymer. The embedded polymer having the first functional group is designed to act as an ‘anchor’ for the grafting of the charged polymer having a second functional group. This is designed to create a stable base for reaction with the functional group of the functional group(s) of the charged polymer.

The PVP or PVP copolymer of the present invention miscible with the membrane formation material such as PVDF can also react with the charged polymeric material for improved operational stability. The preferred PVP derivatives comprise neutral poly(vinylpyrrolidone) (PVP) polymers and poly(vinylpyrrolidone)/vinylacetate copolymers. PVP and PVP/VA copolymer are miscible with several widely used membrane formation materials.

The preferred ratio of membrane material polymer to first polymer (i.e., “embedded polymer’) in the membrane making solution is between about approximately 1.5 to about approximately 5, more preferably between about approximately 2.0 to about approximately 4.0, and most preferably between about approximately 2.5 to about approximately 3.5.

The preferred concentration of the membrane material polymer in the membrane making solution is between about approximately 15% to about approximately 35%, more preferably between about approximately 17% to about approximately 30%.

The membrane with the embedded first polymer is rendered charged by immersing the membrane in a dilute solution of a charged polymer having a second functional group dissolved in an appropriate solvent such as water, ethanol, methanol or isopropanol. This solution may also contain (1) a free radical initiator, or (2) a free radical initiator and reducing agent. Alternatively, the embedded membrane may be immersed in separate dilute solutions containing any one of a free radical initiator, a charged polymer having a second functional group or reducing agent in an appropriate solvent.

The preferred charged polymers comprise positively charged, negatively charged and zwitterionic PVP copolymers, for excellent adhesion with the embedded polymer in the support membrane substrate and ease of solubility in water. The method of the present invention provides for the provision of positively charged, negatively charged and zwitterionic membranes such that a membrane can be manufactured for a specific application, such as the removal of particular charged contaminants including virus or colour removal or metal waste removal.

“Zwitterion” or “zwitterionic material” refers to a macromolecule, material, or moiety possessing both cationic and anionic groups. In most cases, these charged groups are balanced, resulting in a material with zero net charge. Zwitterionic polymers may include both polyampholytes (e.g., polymers with the charged groups on different monomer units) and polybetaine (polymers with the anionic and cationic groups on the same monomer unit).

Preferred charged polymers can be copolymers of polyvinylpyrrolidone. Monomers containing negatively charged groups useful for making polyvinylpyrrolidone copolymers include as representative examples, without being limited by such examples; sulfonated acrylic monomers; e.g., 2-sulfoethylmethacrylate (2-SEM), 2-Propylacrylic acid, 2-acrylamide-2-methyl propane sulfonic acid (AMPS), sulfonated glycidylmethacrylate, 3-sulfopropyl methacrylate, sodium 1-allyloxy-2 hydroxypropyl sulfonate and the like; other example monomers are acrylic and methacrylic acid or their salts, sodium styrene sulfonate, styrene sulfonic acid, sulfonated vinylbenzyl chloride sodium 1-allyloxy-2 hydroxypropyl sulfonate, 4-Vinylbenzoic acid, Trichloroacrylic acid, vinyl phosphoric acid and vinyl sulfonic acid.

Monomers containing positively charged groups useful for making polyvinylpyrrolidone copolymers include as representative examples, without being limited by such examples; Methacrylamidopropyltrimethyl ammonium chloride, trimethylammoniumethylmethacrylate, vinyl pyridine, diallylamine, and disallyl dimethyl ammonium chloride.

A preferred negatively charged PVP copolymer used in the method of the present invention comprise PVP copolymers having sulfonic acid or carboxylic acid groups. In particularly preferred embodiments, a PVP/acrylic acid copolymer is used.

A preferred positively charged PVP copolymer used in the method of the present invention comprise PVP copolymers having N+ groups. In particularly preferred embodiments, poly(vinylpyrrolidone/alkylaminomethacrylate) copolymer, poly(vinylpyrrolidone/alkylaminomethacrylamide) copolymer, or poly(vinylpyrrolidone/methacrylamidopropyl trimethylammonium chloride) copolymer are used.

A preferred zwitterionic PVP copolymer used in the method of the present invention comprise PVP copolymers having aminosulfonic acid or aminocarboxylic acid groups. In particularly preferred embodiments, poly(vinylpyrrolidone/aminosulfonic acid acrylate), poly(vinylpyrrolidone/aminosulfonic acid methacrylate) copolymers, poly(vinylpyrrolidone/aminocarboxylic acid acrylate) copolymers and poly(vinylpyrrolidone/aminocarboxylic acid methacrylate) copolymers may be used.

The embedded membrane may be contacted with the charged polymer solution by several methods. In general the solution will comprise a solvent that wets the membrane substrate so that the surfaces are intimately contacted with the solution and having a second polymer concentration that results in a viscosity suitable for penetration into the porous structure of the porous substrate at a reasonable rate. In one embodiment, the membrane is contacted with the charged polymer solution by soaking. In alternative embodiments, the membrane is contacted with the charged polymer solution by filtration. In the filtration method, the solution of the second polymer is passed through the membrane by pressure or other motive force. The contact period, either by soaking or filtration, can last for a few minutes to approximately 30 minutes. Without wishing to be bound by theory, it is believed that the soaking process can be used to significantly improve the permeability of the coated membrane in comparison with the untreated membrane.

The concentration of the solution of the charged polymer having the second functional group is preferably between 0.5 wt % and 10 wt %. In preferred embodiments, the concentration of the solution of the charged polymer having the second functional group is between 0.5 wt % and 5 wt %.

Alternatively, the filtration process is used to give improved stability to the membrane coating, although the permeability increase is less marked. The embedded membrane may thus be treated by soaking in a charged polymer solution or by filtering the charged polymer solution or using both processes depending on the properties required for the final treated membrane.

The concentration of the charged polymer in solution is preferably between 0.5 wt % and 10 wt %. In particularly preferred embodiments, the charged polymer is between 0.5 wt % and 5 wt % in solution. These concentrations will vary depending on the desired viscosity of the charged polymer solution to give the permeation and density of coating required in the final application of the membrane.

Without being bound by theory it is believed that grafting occurs via free-radical attack and hydrogen abstraction on polyvinylpyrrolidone segments of both the ‘anchor’ and charged polymers. Subsequent termination (or combination) between the anchor and charged polymers lead to covalent grafting. Other mechanisms' e.g., hydrogen bonding, may contribute to the bonding of the charged polymer to the first polymer.

The result is to bind the charged polymer to the ‘anchor’ polymer embedded in the membrane so as to form a highly stable water insoluble gel. The charged gel allows for the absorption of oppositely charged species, or the repulsion of similarly charged species, and produces a hydrophobic membrane. Each of these attributes or any combination of these attributes enhances the utility and value of the membranes.

The free radical initiator present in the dilute solution of the charged polymer is selected from any group of persulfate, peroxide or azo compound. Examples of suitable polymerization initiators include, but are not meant to be limited to; ammonium persulfate, potassium persulfate, sodium persulfate, 4,4′-azobis(4-cyanovaleric acid) 2,2′-azobis(2-amidinopropane)hydrochloride, potassium hydrogen persulfate (Oxone; DuPont). Depending on the solvent used, other initiators may be used, as, for example, benzoyl peroxide (BPO), 2,2′-azobisisobutyronitrile (AIBN), 2,2′-azobis(2-methylpropionamidine)dihydrochloride, 2,2′-Azobis[2-(2-imidazolin-2-yl)propane]dihydrochloride, 2,2′-Azobis[2-(2-imidazolin-2-yl)propane] and dimethyl 2,2′-azobis(2-methylpropionate).

A particularly preferred free radical initiator is ammonium persulfate. The free radical initiator is preferably present in solution at a concentration of between 0.5 wt % and 5 wt %. More preferably, the free radical initiator is present in solution at a concentration between 0.5 wt % and 2 wt %.

When a redox couple initiator is desired, oxidizing initiators such as persulfates, preferably ammonium persulfate, are used with reducing agents such as bisulfides, sulfur dioxide, or ascorbic acid. Bisulfides include as non-limiting examples, sodium sulfite, sodium bisulfite, ketone bisulfite, and glyoxal bisulfite. A transition metal may be incorporated into the redox system to control the generation of free radicals. The use of transition metals and levels of addition to form a redox system for polymerization mediums are well-known.

The reducing agent is preferably selected from a group consisting of a compound containing a transition metal ion (such as Fe²⁺, Zn²⁺, Cr²⁺, V²⁺, Ti³⁺, Co²⁺ and Cu⁺), or a compound comprising an ammonium, amine, amide, modified ammonium, modified amine or modified amide group. In preferred embodiments, the reducing agent is selected from a group consisting of triethylmethylenediamine, pentamethyldiethylene triamine, ammonium bisulfite and zinc chloride. The reducing agent is preferably present in solution at a concentration of between 0.5 wt % and 5 wt %. More preferably, the reducing agent is present in solution at a concentration between 0.5 wt % and 2 wt %.

Another preferred reducing agent is tetraethylenediamine (TEMED).

Conventional energy sources which may be used for initiating free radical polymerization are thermal (heating), ultraviolet light, gamma radiation, electron beam radiation. Electron beam and gamma radiation may be used without an initiator to polymerize and crosslink polymers.

Particular preferred embodiments comprise ammonium persulfate, sodium persulfate and potassium persulfate. Ammonium persulfate is a particularly preferred embodiment. The free radical initiator is used in a concentration between 0.5 wt % and 5 wt % in solution. In particularly preferred embodiments, the free radical initiator is at a concentration between 0.5 wt % and 2 wt % in solution.

The free radical initiator is used to initiate grafting of the functional group(s) of the charged polymer with the functional group(s) of the polymer ‘anchor’ embedded in the membrane. The free radical initiator is not chemically bound to the coating of the membrane and can be removed along with excess un-grafted polymer by washing in a suitable solvent. One significant advantage of this invention is that the charged polymer can be reacted and grafted with the embedded polymer such that a water insoluble gel is formed. This provides a charged membrane surface that is highly stable, with a chemical bond between the membrane coating and the membrane structure, which is insoluble in an aqueous feedstream during operation of the membrane.

The free radical initiator may also be used in conjunction with a reducing agent. The grafting of the functional groups(s) of the embedded polymer and the functional group(s) of the charged polymer can be finished under a thermal source, using a redox intiation source or under a radiation source, preferably a combination of a thermal, redox and radiation source.

In an alternative embodiment, the membrane may be contacted with consecutive coating layers of positively and negatively charged polymers, which is then followed by optional cross-linking treatment if required for stability. This can be used for the generation of membranes for the removal of particular contaminants from solution such as the removal of particular charged contaminants including virus or colour removal or metal waste removal or for the adsorption/repellence of a specific foulant.

Preparation of the Charged Membrane According to the Method of the Invention May be conducted at temperatures ranging from room temperature (i.e. ˜20° C.) to 100° C.

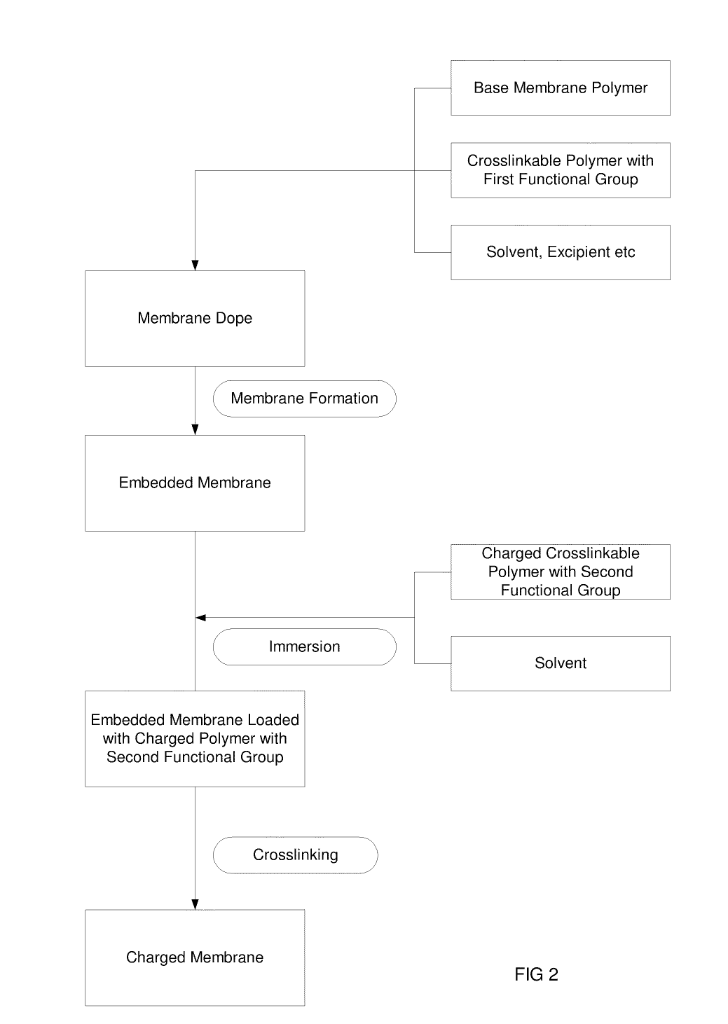

FIG. 2 is a flow chart illustrating a method of membrane production according to various embodiments of the present invention. Base membrane polymer, crosslinkable polymer with a first functional group, and solvent, excipient and the like can be used to dope a membrane. This is generally referred to as membrane formation, which in return can be an embedded membrane. Immersion can occur when a charged crosslinkable polymer with a second functional group is combined with a solvent and the embedded membrane. Now there is an embedded membrane loaded with charged polymer with a second functional group. Then, a charged membrane is created via crosslinking.

### EXPERIMENTAL

### Formation of Insoluble Gel by Grafting Polymer Having First Functional Group with Charged Polymer Having Second Functional Group

The formation of an insoluble gel using the method of the invention was demonstrated in the following examples of Table 1. This data demonstrates the formation of an insoluble gel by the reaction between a polymer having a first functional group (PVP or PVP/VA) and a charged polymer having a second functional group. The inventors observed a gel coating on the fibers after reaction that was not removed by prolonged soaking in water.

PVDF hollow-fibre membrane samples were treated via soaking in the chemical solutions under the conditions listed in Table 1. The formation of an insoluble gel due to the grafting of the respective first and second functional groups on the membrane surface and/or in the membrane pores of the samples is also indicated in Table 1.

TABLE 1
Membrane samples prepared in the laboratory using the method of the present
invention

| | Polymer | | | | Formation |
|---|---|---|---|---|---|
| | having first | | Polymer having | Time and | of |
| | functional | Free Radical | second functional | temperature of | insoluble |
| Sample | group | Initiator | group | treatment | gel |
| 1 | 10 wt % | 5% | 1% HS-100^{#} | 70° C. for 2 hours | Yes |
| | PVP/VA* | (NH₄)₂S₂O₈** | | | |
| 2 | 10 wt % | 5% | 1.5% HS-100^{#} | 70° C. for 2 hours | Yes |
| | PVP/VA* | (NH₄)₂S₂O₈** | | | |
| 3 | 10 wt % | 5% | 1% HS-100^{#} | 85° C. for 2 hours | No |
| | PVP¹* | (NH₄)₂S₂O₈** | | | |
| 4 | 2 wt % PVP° | 5% | 1% HS-100^{#} | 85° C. for 2 hours | Yes |
| | | (NH₄)₂S₂O₈** | | | |
| 5 | 10 wt % | 5% | 1% co-polymer | 85° C. for 1 hours | Yes |
| | PVP/VA* | (NH₄)₂S₂O₈** | 845^{a} | | |
| 6 | 10 wt % | 5% | 1% co-polymer | 85° C. for 1 hours | No |
| | PVP¹* | (NH₄)₂S₂O₈** | 845^{a} | | |
| 7 | 2 wt % PVP° | 5% | 1% co-polymer | 85° C. for 1 hours | Yes |
| | | (NH₄)₂S₂O₈** | 845^{a} | | |
| 8 | 10 wt % | 5% | 5% HS-100^{#} | 70° C. for 1 hours | Yes |
| | PVP¹* | (NH₄)₂S₂O₈** | | | |
| 9 | 2 wt % PVP° | — | 1% co-polymer | Gamma radiation | Yes |
| | | | 845^{a} | | |
| 10 | 10 wt % | — | 1% co-polymer | Gamma radiation | Yes |
| | PVP/VA* | | 845^{a} | | |
| 11 | 10 wt % | — | 1% co-polymer | Gamma radiation | Yes |
| | PVP¹* | | 845^{a} | | |
| 12 | 2 wt % PVP° | — | 1% HS-100^{#} | Gamma radiation | Yes |
| 13 | 10 wt % | — | 1% HS-100^{#} | Gamma radiation | Yes |
| | PVP¹* | | | | |
| 14 | — | 5% | 5% HS-100^{#} | 70° C. for 1 hours | No |
| | | (NH₄)₂S₂O₈** | | | |

All percentages given in Table 1 are percentages by weight.

### Definition of Symbols Used in Table 1

*=poly(vinylpyrrolidone/vinylacetate) copolymer—ISP commercial grade PVP/VA-S630;
**=ammonium persulfate;
^{#}=poly(vinylpyrrolidone/methacrylamidopropyl trimethylammonium chloride—ISP commercial grade Gafquat® HS-100;
¹=poly(vinylpyrrolidone)=ISP commercial grade PVP K-30;
°=poly(vinylpyrrolidone)=ISP commercial grade PVP K-90;
^{a}=1% poly(vinylpyrrolidone/dimethylaminoethylmethacrylate) copolymer—ISP co-polymer 845;

It should be noted that the difference in result between Examples 3 and 4 of Table 1 is understood to be related to the difference in molecular weight of the PVP samples used (PVP K-30 has a lower molecular weight than PVP K-90). Without wishing to be bound by theory, the polymer having a first functional group, when used in the method of the present invention, should have a molecular weight such that the number of chain linkages created between polymer chains on the respective polymer backbones are numerous enough to secure and anchor the charged polymer.

### CONCLUSIONS

These examples demonstrate that the use of PVP and PVP/VA copolymers can achieve formation of an insoluble gel on a membrane surface and/or in membrane pores using the method of the invention. Using the thermal grafting methods of Examples 1 to 8, the PVP and copolymer used are of a molecular weight such that linkages are formed between polymer chains on the respective polymer backbones. Examples 8 to 12 demonstrate the effectiveness of gamma radiation in achieving the formation of insoluble gel using the chemical species of the present invention. Example 14 demonstrates that, for a membrane prepared without the polymer ‘anchor’ with the first functional group, formation of an insoluble gel on a membrane surface and/or in membrane pores using the method of the invention was not observed.

### Preparation of Charged Membranes

### Membrane Formation—DIPS Procedure.

Hollow fibre membranes were produced according to the method of the invention using a standard DIPS process as follows:

Polymer solutions containing between 15 and 30 wt % polyvinylidene difluoride (PVDF) and approximately 10 wt % poly(vinylpyrrolidone/vinylacetate) (PVP-VA) were mixed and heated to around 80° C. and pumped (spun) through a die into a 5 metre water-filled quench (or solidification) bath at 65° C. Non-solvent (lumen) containing water was fed through the inside of the die to form the lumen. The hollow fibre was then spun into the quench bath and solidified, before being run out of the bath over driven rollers onto a winder situated in a secondary water bath at room temperature to complete the quench and washing of the fibre.

The following examples disclose the preparation of charged polymer hollow fibre membranes using the method of the invention. These examples represent an embodiment of the invention only. The invention can be used in many other forms and is not restricted to such examples only.

### Examples 1 and 2

### Soaking Treatment

### Example 1

A PVDF/PVP-VA blended hollow fibre membrane was prepared according to the DIPS process outlined above. After washing and drying as described, the PVDF membrane was immersed into an aqueous solution containing 1 wt % ammonium persulfate and 5 wt % poly(vinylpyrrolidone/methacrylamidopropyl trimethylammonium chloride) (HS-100) for 60 minutes. The solution-loaded PVDF membrane was placed into a plastic bag, which was then sealed under nitrogen. While in the sealed bag, the membrane was exposed to a temperature of 70° C. for 60 minutes. The sealed bag is used to maintain the inert nitrogen atmosphere and chemical treatment around the membrane during the treatment time. Following treatment, the membrane was thoroughly washed with water and dried. Elemental analysis and weight gain experiments showed surface grafting was successful (see Table 2). Measurement of the hollow fibre membrane water permeability at 100 kPa revealed an improvement in permeability from 117 Lm⁻²H⁻¹ for the untreated membrane to 357 Lm⁻²H⁻¹ for the treated membrane. The treated membrane also had a 3.1% weight gain. The treated membrane was significantly more permeable than the untreated PVDF/PVP-VA membrane.

### Example 2

As a comparison to Example 1, a PVDF/PVP-VA blended hollow fibre membrane was prepared according to the DIPS process outlined above. After washing and drying as described, the PVDF membrane was immersed into an aqueous solution containing 5 wt % ammonium persulfate, and 5 wt % poly(vinylpyrrolidone/methacrylamidopropyl trimethylammonium chloride) (HS-100) for 60 minutes. The solution-loaded PVDF membrane was placed into a plastic bag, which was then sealed under nitrogen. While in the sealed bag, the membrane was exposed to a temperature of 70° C. for 60 minutes. The sealed bag is used to maintain the inert nitrogen atmosphere and chemical treatment around the membrane during the treatment time. Elemental analysis and weight gain experiments showed surface grafting was successful (see Table 2). Measurement of the hollow fibre membrane water permeability at 100 kPa revealed an improvement in permeability from 140 Lm⁻²H⁻¹ for the untreated membrane to 301 Lm⁻²H⁻¹ for the treated membrane. The treated membrane also had 3.3% weight gain. The treated membrane was significantly more permeable than the untreated PVDF/PVP-VA membrane.

### Example 3

### Room Temperature Surface Grafting Experiment

### Example 3

A PVDF/PVP-VA blended hollow fibre membrane was prepared according to the DIPS process outlined above. After washing and drying as described, the PVDF membrane was immersed into a solution of 5 wt % benzoyl peroxide (BPO) in tetrahydrofuran (THF) for 30 minutes at room temperature. Afterwards, the membrane was removed, dried and immersed into an aqueous solution containing 5 wt % poly(vinylpyrrolidone/methacrylamidopropyl trimethylammonium chloride) (HS-100) and 5 wt % tetraethylenediamine (TEMED) for 24 hours at room temperature. Elemental analysis and weight gain experiments showed surface grafting was successful (see Table 2). Measurement of the hollow fibre membrane water permeability at 100 kPa revealed an improvement in permeability from 128 Lm⁻²H⁻¹ for the untreated membrane to 304 Lm⁻²H⁻¹ for the treated membrane. The treated membrane also had 4.0% weight gain. The treated membrane was significantly more permeable than the untreated PVDF/PVP-VA membrane.

In comparison to Examples 1 and 2, Example 3 illustrates that the fibre treatment can be successfully performed at room temperature and in conjunction with a reducing agent according to the method of the invention.

### Comparative Examples

### Comparative Example 1

As a comparison to Example 1 above, a PVDF hollow fibre membrane (ie prepared without PVP-VA) was prepared according to the DIPS process outlined above in Example 1. After washing and drying as described, the PVDF membrane was immersed into an aqueous solution containing 1 wt % ammonium persulfate and 5 wt % poly(vinylpyrrolidone/methacrylamidopropyl trimethylammonium chloride) (HS-100) for 60 minutes. The solution-loaded PVDF membrane was placed into a plastic bag, which was then sealed under nitrogen. While in the sealed bag, the membrane was exposed to a temperature of 70° C. for 60 minutes. The sealed bag is used to maintain the inert nitrogen atmosphere and chemical treatment around the membrane during the treatment time. Following treatment, the membrane was thoroughly washed with water and dried. Elemental analysis and weight gain experiments showed surface grafting was successful (see Table 2). Measurement of the hollow fibre membrane water permeability at 100 kPa revealed an improvement in permeability from 96 Lm⁻²H⁻¹ for the untreated membrane to 164 Lm⁻²H⁻¹ for the treated membrane. The treated membrane also had 1.9% weight gain. The treated membrane was only slightly more permeable than the untreated PVDF membrane.

In comparison to Example 1, this result illustrates that a higher surface grafting density and final fibre permeability can be achieved for a fibre containing the PVP-VA ‘anchor’ according to the method of the invention.

### Comparative Example 2

As a comparison to Example 2 above, a PVDF hollow fibre membrane (ie prepared without PVP-VA) was prepared according to the DIPS process outlined above in Example 2. After washing and drying as described, the PVDF membrane was immersed into an aqueous solution containing 5 wt % ammonium persulfate, and 5 wt % poly(vinylpyrrolidone/methacrylamidopropyl trimethylammonium chloride) (HS-100) for 60 minutes. The solution-loaded PVDF membrane was placed into a plastic bag, which was then sealed under nitrogen. While in the sealed bag, the membrane was exposed to a temperature of 70° C. for 60 minutes. The sealed bag is used to maintain the inert nitrogen atmosphere and chemical treatment around the membrane during the treatment time. Elemental analysis and weight gain experiments showed surface grafting was successful (see Table 2). Measurement of the hollow fibre membrane water permeability at 100 kPa revealed an improvement in permeability from 82 Lm⁻²H⁻¹ for the untreated membrane to 158 Lm⁻²H⁻¹ for the treated membrane. The treated membrane also had 2.4% weight gain. The treated membrane was only slightly more permeable than the untreated PVDF membrane.

In comparison to Example 2, this result illustrates that a higher surface grafting density and final fibre permeability can be achieved for a fibre containing the PVP-VA ‘anchor’ according to the method of the invention.

### Comparative Example 3

### Room Temperature Surface Grafting Experiment

### Comparative Example 3

As a comparison to Example 3 above, a PVDF hollow fibre membrane (ie prepared without PVP-VA) was prepared according to the DIPS process outlined above. After washing and drying as described, the PVDF membrane was immersed into a solution of 5 wt % benzoyl peroxide (BPO) in tetrahydrofuran (THF) for 30 minutes at room temperature. Afterwards, the membrane was removed, dried and immersed into an aqueous solution containing 5 wt % poly(vinylpyrrolidone/methacrylamidopropyl trimethylammonium chloride) (HS-100) and 5 wt % tetraethylenediamine (TEMED) for 24 hours at room temperature. Elemental analysis and weight gain experiments showed surface grafting was successful (see Table 2). Measurement of the hollow fibre membrane water permeability at 100 kPa revealed an improvement in permeability from 109 Lm⁻²H⁻¹ for the untreated membrane to 145 Lm⁻²H⁻¹ for the treated membrane. The treated membrane also had 2.0% weight gain. The treated membrane was only slightly more permeable than the untreated PVDF membrane.

In comparison to Example 3, this result illustrates that a higher surface grafting density and final fibre permeability can be achieved for a fibre containing the PVP-VA ‘anchor’ according to the method of the invention.

The observed percentage weight gain and elemental analysis of grafted hollow fibre membranes from the Examples and Comparative Examples are shown in Table 2. These results were obtained using energy-dispersive x-ray spectroscopy (EDAX). Examples 1 to 4 provide results for membranes containing PVP-VA, whereas comparative examples C1 to C4 did not contain PVP-VA. These results show that surface grafting yield and the resulting membrane permeability is improved for membranes containing PVP-VA.

A relative figure of merit is the increase in nitrogen percentage in the membrane. This is related to the amount of trimethylammonium in the membrane after reaction and washing. Table 1A below gives these results.

TABLE 1A
Increase in % N
(% N Reacted membrane-% N Unreacted membrane)

| % APS Used | Experimental | Comparative |
|---|---|---|
| 1 | 3.1 | 1.8 |
| 5 | 8.7 | 3.7 |
| (5% BPO-TEMED) | 3.7 | 0.8 |

It is observed that the amount of positively charged trimethylammonium is greater in the experimental membrane. Further, the effect of the amount of free radical initiator is shown by the higher N % for the 5% APS compared to the 1% APS. Also, the 5% APS gave a higher % N than the 5% BPO in each set of reactions. Therefore, a practitioner will be able to better control charged group grafting by varying initiator amount and type.

The examples given above demonstrate success of the technique is achieving surface grafting. Examples relating to improved targeted contaminant removal are given below in Table 2, where the membrane performance is compared for virus removal.

TABLE 2
Percentage weight gain and elemental analysis

| | | | | | | C2 | C3 | C4 |
|---|---|---|---|---|---|---|---|---|
| | | 2 | 3 | 4 | | Comparative | Comparative | Comparative |
| Comment | 1 | Example 1 | Example 2 | Example 3 | C1 | Example 1 | Example 2 | Example 3 |
| Hollow Fibre | | | | | | | | |
| Formulation | | | | | | | | |
| Base Membrane Polymer | 25% PVDF | 25% PVDF | 25% PVDF | 25% PVDF | 17% PVDF | 17% PVDF | 17% PVDF | 17% PVDF |
| First Functional Polymer | 10% PVP- | 10% PVP- | 10% PVP- | 10% PVP- | — | — | — | — |
| | VA | VA | VA | VA | | | | |
| Solvent | NMP | NMP | NMP | NMP | NMP | NMP | NMP | NMP |
| Coagulant | Water | Water | Water | Water | Water | Water | Water | Water |
| Treatment Solution 1 | | | | | | | | |
| Radical Initiator | | 1% APS | 5% APS | 5% BPO | | 1% APS | 5% APS | 5% BPO |
| Second Functional | | 1% HS-100 | 5% HS-100 | | | 1% HS-100 | 5% HS-100 | |
| Polymer | | | | | | | | |
| Solvent | | Water | Water | THF | | Water | Water | THF |
| Treatment temperature | | 70° C. | 70° C. | R.T. | | 70° C. | 70° C. | R.T. |
| Treatment Time | | 1 hr | 1 hr | 24 hr | | 1 hr | 1 hr | 24 hr |
| Treatment Solution 2 | | | | | | | | |
| Redox Pair | | | | 5% TEMED | | | | 5% TEMED |
| Grafting Polymer Additive | | | | 5% HS-100 | | | | 5% HS-100 |
| Solvent | | | | Water | | | | Water |
| Treatment temperature | | | | R.T. | | | | R.T. |
| Treatment Time | | | | 24 hr | | | | 24 hr |
| EDAX Results | | | | | | | | |
| C (%) | 48 | 37.4 | 36.2 | 34.4 | 51 | 36.8 | 37.2 | 35.4 |
| O (%) | 3.9 | 8.4 | 27.5 | 8.6 | 3.8 | 6.9 | 13.0 | 5.5 |
| N (%) | 4.9 | 8.0 | 13.6 | 8.6 | 4.7 | 6.5 | 8.4 | 5.5 |
| F (%) | 43 | 46.2 | 22.8 | 48.4 | 40 | 49.8 | 41.5 | 53.5 |
| Weight Gain (wt %) | — | +3.1 wt % | +3.3 wt % | +4.0 wt % | — | +1.9 wt % | +2.4 wt % | +2.0 wt % |
| Initial Permeability | — | 117 | 130 | 128 | — | 96 | 82 | 109 |
| (LMH) | | | | | | | | |
| Final Permeability | — | 357 | 220 | 304 | — | 164 | 158 | 145 |
| (LMH) | | | | | | | | |

LMH = liters/m²/hr

### Virus Retention

A surprising advantage of the method of the invention is the degree of improved virus retention that the charged membranes possess in comparison with an uncharged membrane of similar composition. Without wishing to be bound by theory, it is believed to the moderate negative charge maintained by a number of common virus particles may interact with the charge of the membrane during filtration of a virus-containing solution.

A number of small membrane modules made following extrusion of fibre using the DIPS process as outlined previously. A PVDF/PVP-VA base membrane was extruded using two different formulations (Formulation A and Formulation B). Two of these small modules (one of each made from Formulation A and Formulation B) were then soaked in a treatment solution for a given time followed by heat treatment in a sealed bag according to the method used in Example 1. These were then tested for virus retention and compared to untreated membranes of similar compositions. Diluted aliquots of feed and permeate are inoculated onto cell monolayers of a bacteria that is susceptible to infection by the virus being tested. This is usually done in a Petri dish. In a following incubation period viruses present in test liquid infect the cells. The monolayers are then covered with a nutrient medium containing agar or a similar thickening agent to form a gel. The plates are incubated and the infected cells release viral progeny. The spread of the new viruses is restricted to neighboring cells by the gel, forming a circular zone of infected cells called a plaque. Eventually the plaque becomes large enough to be visible to the naked eye and can be counted. Each plaque is taken as a single virus. Calculating retention is a matter of calculating the concentration of virus in the feed and permeate from the dilution factor and then % Retention=(1−concentration in permeate/concentration in feed) 100%

These results are summarised in Table 2.

TABLE 2
Virus retention of charged and uncharged small membrane modules

| | | Membrane | | LRV |
|---|---|---|---|---|
| Base Membrane | Solution for | soaking | Heat treatment | (MS2 |
| formulation | soaking treatment | time | temperature/time | rejection) |
| A | None | — | — | 4.6 |
| 28% PVDF/10% PVP/VA | | | | |
| Balance NMP | | | | |
| A | 5 wt % ammonium | 60 min | 80° C. for 120 | 5.3 |
| | persulfate, | | minutes | |
| | and 2 wt % HS-100 | | | |
| B | None | — | — | 3.6 |
| 25% PVDF/8% PVP/VA | | | | |
| Balance NMP | | | | |
| B | 5 wt % ammonium | 60 min | 80° C. for 120 | 4.1 |
| | persulfate, | | minutes | |
| | and 2 wt % HS-100 | | | |

HS 100 = poly(vinylpyrrolidone/methacrylamidopropyl trimethylammonium chloride)
PVP/VA = polyvinylpyrrolidone/vinyl acetate copolymer

The virus retention results in Table 2 indicate the improved virus retention of a charged membrane when compared to an untreated membrane of the same formulation, using two different base membrane formulations for confirmation of this result.

We claim:

1. A charged porous polymeric membrane comprising:
a porous polymeric membrane substrate comprising a polymeric membrane material and a first polymer having a first functional group, said first polymer compatible with the membrane material, and,
a charged polymer having a second functional group,
said charged polymer reacted with said first polymer to bond said charged polymer to said first polymer,
forming a charged coating on the membrane outer and inner surfaces.

2. The membrane of claim 1 wherein the polymeric membrane material comprises a polymer selected from the group consisting of polyvinylidene difluoride (PVDF), polyethersulfone (PES), polysulfone (PSf), polyacrylonitrile (PAN) or cellulose acetate (CA).

3. The membrane of claim 1 wherein the membrane comprises a hollow fiber membrane.

4. The membrane of claim 3 wherein the membrane comprises a microporous membrane.

5. The membrane of claim 3 wherein the membrane comprises an ultrafiltration membrane.

6. The membrane of claim 1 wherein the polymeric membrane material comprises polyvinylidene difluoride (PVDF).

7. The membrane of claim 1 wherein the polymeric membrane material comprises a semi-crystalline polymer.

8. The charged porous polymeric membrane of claim 1 wherein said first polymer having said first functional group comprises more than one polymer species.

9. The polymers of claim 8 wherein said first functional group comprises more than one functional group.

10. The membrane of claim 1 wherein the first polymer comprises polyvinylpyrrolidone or copolymers of polyvinylpyrrolidone.

11. The membrane of claim 1 wherein the first polymer comprises a poly(vinylpyrrolidone)/vinylacetate copolymer.

12. The membrane of claim 1 wherein the first polymer comprises a polymer compatible with the polymeric membrane material.

13. The membrane of claim 1 wherein the charged polymer is a negatively charged polymer.

14. The membrane of claim 1 wherein the charged polymer is a positively charged polymer.

15. The membrane of claim 1 wherein the charged polymer is a zwitterion.

16. The charged porous polymeric membrane according to claim 13 wherein said negatively charged PVP copolymer is selected from the group consisting of PVP copolymers having sulfonic acid or carboxylic acid groups.

17. The charged porous polymeric membrane according to claim 16 wherein said positively charged PVP copolymer is selected from a group consisting of PVP copolymers having positively charged amine, amide, modified amine or modified amide groups.

18. The charged porous polymeric membrane according to claim 17 wherein said positively charged PVP copolymer is selected from the group consisting of poly(vinylpyrrolidone/alkylaminomethacrylate) copolymer, poly(vinylpyrrolidone/alkylaminomethacrylamide) copolymer, and poly(vinylpyrrolidone/methacrylamidopropyl trimethylammonium chloride) copolymer.

19. The charged porous polymeric membrane according to claim 14 wherein said positively charged PVP copolymer is poly(vinylpyrrolidone/methacrylamidopropyl trimethylammonium chloride).

20. The charged porous polymeric membrane according to claim 14 wherein said positively charged PVP copolymer is poly(vinylpyrrolidone/dimethylaminoethylmethacrylate) copolymer.

21. The charged porous polymeric membrane according to claim 15 wherein said zwitterionic PVP copolymer is selected from the group consisting of PVP copolymers having both positively and negatively charged amine, amide, modified amine or modified amide groups or any combination thereof.

22. The charged porous polymeric membrane according to claim 1, wherein the coated membrane has a permeability no less than the membrane substrate.

23. The membrane of claim 22 wherein the polymeric membrane material comprises a polymer selected from the group consisting of polyvinylidene difluoride (PVDF), polyethersulfone (PES), polysulfone (PSf), polyacrylonitrile (PAN) or cellulose acetate (CA).

24. The membrane of claim 22 wherein the polymeric membrane material comprises polyvinylidene difluoride (PVDF).

25. The membrane of claim 22 wherein the polymeric membrane material comprises a semi-crystalline polymer.

26. The charged porous polymeric membrane of claim 22 wherein said first polymer having said first functional group comprises more than one polymer species.

27. The polymers of claim 26 wherein said first functional group comprises more than one functional group.

28. The membrane of claim 22 wherein the first polymer comprises polyvinylpyrrolidone or copolymers of polyvinylpyrrolidone.

29. The membrane of claim 22 wherein the first polymer comprises a poly(vinylpyrrolidone)/vinylacetate copolymer.

30. The membrane of claim 22 wherein the first polymer comprises a polymer compatible with the polymeric membrane material.

31. The membrane of claim 22 wherein the charged polymer is a negatively charged polymer.

32. The membrane of claim 22 wherein the charged polymer is a positively charged polymer.

33. The membrane of claim 22 wherein the charged polymer is a zwitterion.

34. The charged porous polymeric membrane according to claim 31 wherein said negatively charged PVP copolymer is selected from the group consisting of PVP copolymers having sulfonic acid or carboxylic acid groups.

35. The charged porous polymeric membrane according to claim 32 wherein said positively charged PVP copolymer is selected from the group consisting of PVP copolymers having positively charged amine, amide, modified amine or modified amide groups.

36. The charged porous polymeric membrane according to claim 35 wherein said positively charged PVP copolymer is selected from the group consisting of poly(vinylpyrrolidone/alkylaminomethacrylate) copolymer, poly(vinylpyrrolidone/alkylaminomethacrylamide) copolymer, and poly(vinylpyrrolidone/methacrylamidopropyl trimethylammonium chloride) copolymer.

37. The charged porous polymeric membrane according to claim 29 wherein said positively charged PVP copolymer is poly(vinylpyrrolidone/methacrylamidopropyl trimethylammonium chloride).

38. The charged porous polymeric membrane according to claim 32 wherein said positively charged PVP copolymer is poly(vinylpyrrolidone/dimethylaminoethylmethacrylate) copolymer.

39. The charged porous polymeric membrane according to claim 33 wherein said zwitterionic PVP copolymer is selected from a group consisting of PVP copolymers having both positively and negatively charged amine, amide, modified amine or modified amide groups or any combination thereof.

40. A method of manufacturing a charged porous membrane comprising;
providing a porous membrane substrate comprising a membrane material polymer and an embedded first polymer,
reacting said first polymer with a charged polymer to bond said charged polymer to said first polymer,
thereby forming a charged polymeric coating on the surface of the membrane substrate.

41. The method of claim 40 wherein the polymeric membrane material comprises a polymer selected from the group consisting of polyvinylidene difluoride (PVDF), polyethersulfone (PES), polysulfone (PSf), polyacrylonitrile (PAN) or cellulose acetate (CA).

42. The method of claim 40 wherein the polymeric membrane material comprises polyvinylidene difluoride (PVDF).

43. The method of claim 40 wherein the polymeric membrane material comprises a semi-crystalline polymer.

44. The method of claim 40 wherein said first polymer comprises more than one polymer species.

45. The method of claim 40 wherein the first polymer comprises polyvinylpyrrolidone or copolymers of polyvinylpyrrolidone.

46. The method of claim 40 wherein the first polymer comprises poly(vinylpyrrolidone)/vinylacetate copolymer.

47. The method of claim 40 wherein the first polymer comprises a polymer compatible with the polymeric membrane material.

48. The method of claim 40 wherein the charged polymer is a negatively charged polymer.

49. The method of claim 40 wherein the charged polymer is a positively charged polymer.

50. The method of claim 40 wherein the charged polymer is a zwitterion.

51. The charged porous polymeric membrane according to the method of claim 40 wherein said negatively charged PVP copolymer is selected from the group consisting of PVP copolymers having sulfonic acid or carboxylic acid groups.

52. The charged porous polymeric membrane of the method of claim 40 wherein said positively charged PVP copolymer is selected from a group consisting of PVP copolymers having positively charged amine, amide, modified amine or modified amide groups.

53. The charged porous polymeric membrane according to the method of claim 40 wherein said positively charged PVP copolymer is selected from the group consisting of poly(vinylpyrrolidone/alkylaminomethacrylate) copolymer, poly(vinylpyrrolidone/alkylaminomethacrylamide) copolymer, and poly(vinylpyrrolidone/methacrylamidopropyl trimethylammonium chloride) copolymer.

54. The charged porous polymeric membrane according to the method of claim 40 wherein said positively charged PVP copolymer is poly(vinylpyrrolidone/methacrylamidopropyl trimethylammonium chloride).

55. The charged porous polymeric membrane according to the method of claim 40 wherein said positively charged PVP copolymer is poly(vinylpyrrolidone/dimethylaminoethylmethacrylate) copolymer.

56. The charged porous polymeric membrane according to claim 50 wherein said zwitterionic PVP copolymer is selected from the group consisting of PVP copolymers having both positively and negatively charged amine, amide, modified amine or modified amide groups or any combination thereof.

57. The method of claim 40 wherein reacting the first polymer with the charged polymer comprises bringing the membrane substrate in contact with a liquid solution of the charged polymer and causing the solution containing the charged polymer to be brought to a condition where reaction between the charged polymer and the first polymer will occur.

58. The method of claim 57 wherein the liquid comprises water, alcohol, or alcohol-water mixtures.

59. The method of claim 58 wherein the alcohol comprises methanol, ethanol, or propanol.

60. The method of claim 57 wherein the liquid solution contains a free radical initiator.

61. The method of claim 60 wherein the free radical initiator is selected from the group of persulfate, peroxide and azo compounds.

62. The method of claim 60 wherein the free radical initiator is selected from the group of azobiscyanovaleric acid, benzoyl peroxide, ammonium persulfate, sodium persulfate and potassium persulfate.

63. The method of claim 60 wherein the free radical initiator is ammonium persulfate.

64. The method of claim 40 wherein reacting the first polymer with the charged polymer comprises the steps of;
bringing the membrane substrate in contact with a liquid solution of the charged polymer,
optionally removing excess solution to leave the membrane substrate substantially saturated with solution,
irradiating the liquid solution with gamma radiation or electron beam radiation to cause reaction to occur between the charged polymer and the first polymer.

65. The method of claim 40 wherein reacting the first polymer with the charged polymer comprises the steps of:
bringing the membrane substrate in contact with a liquid solution of the charged polymer containing a free radical initiator,
optionally removing excess solution to leave the membrane substrate substantially saturated with solution,
causing the free radical initiator to generate a free radical thereby causing reaction to occur between the charged polymer and the first polymer,
wherein the free radical initiator is caused to generate a free radical by supplying energy to the liquid solution, wherein the supplied energy is selected from the group of thermal, ultraviolet irradiation, electron beam irradiation, gamma irradiation and combinations of said supplied energies.

63. A process for treating a fluid containing viral contaminants, said process comprising placing said fluid in contact with the porous charged membrane of claim 1, and recovering a viral contaminant depleted fluid.

64. The process of claim 63 wherein the porous charged membrane of claim 1 is a microporous membrane.

65. The process of claim 64 wherein the porous membrane is a charged hollow fiber microporous membrane.

66. The process of claim 63 wherein the porous membrane of claim 1 is a charged ultrafiltration membrane.

67. The process of claim 66 wherein the porous membrane is a charged hollow fiber ultrafiltration membrane.
